(19) United States
(12) Patent Application Publication
(10) Pub. No.: US 2026/0068913 A1
(43) Pub. Date: Mar. 12, 2026

(54) SEAWEED STARTER AND PREPARATION METHOD THEREOF

(71) Applicant: GUANGDONG OCEAN UNIVERSITY, Zhanjiang (CN)

(72) Inventors: Saiyi ZHONG, Zhanjiang (CN); Lina WANG, Zhanjiang (CN); Zhuo WANG, Zhanjiang (CN); Bingbing SONG, Zhanjiang (CN); Jieliang ZHANG, Zhanjiang (CN); Shouchun LIU, Zhanjiang (CN); Rui LI, Zhanjiang (CN); Jianping CHEN, Zhanjiang (CN)

(73) Assignee: GUANGDONG OCEAN UNIVERSITY, Zhanjiang (CN)

(21) Appl. No.: 19/387,664

(22) Filed: Nov. 13, 2025

Related U.S. Application Data
(63) Continuation-in-part of application No. PCT/CN2024/072347, filed on Jan. 15, 2024.

(30) Foreign Application Priority Data
May 19, 2023 (CN) 202310567216.5

(51) Int. Cl. A23L 17/60; A23L 17/00; A23L 27/50

(52) U.S. Cl. CPC A23L 17/60; A23L 17/65; A23L 27/50

(57) ABSTRACT

A preparation method of a seaweed starter includes: wetting cooked soybean meal with water, adding wheat meal and stirring same, adding seaweed meal to obtain a fermentation raw material and sterilizing same; adding a starter-making strain spore suspension into the sterilized fermentation raw material, performing constant-temperature culture, and performing ventilation and starter making for 48-96 hours to obtain a seaweed starter. The starter-making strains are aspergillus oryzae and aspergillus niger, and wherein in terms of a mass ratio, a strain ratio of aspergillus oryzae to aspergillus niger is 1:1-1:5, an inoculum amount of the starter-making strain spore suspension is 3-5% of the fermentation raw material, and the seaweed meal is Gracilaria meal; and wherein in terms of a mass ratio, an addition ratio of the cooked soybean meal to the wheat meal to the Gracilaria meal is 5:2:1-3.

### CROSS-REFERENCE TO RELATED APPLICATION

This application is a continuation-in-part of International Application No. PCT/CN2024/072347, filed on Jan. 15, 2024, which claims priority to Chinese Parent Application No. 202310567216.5, filed on May 19, 2023, the entire contents of all of which are incorporated herein by reference.

### BACKGROUND

### Technical Field

The present disclosure generally relates to the field of seaweed resource utilization technologies and relates to an application of seaweed in edible fermented (condiments) products, and especially relates to a seaweed starter and a preparation method thereof.

### Description of Related Art

Seaweed is a good source of protein, containing unique algae flavor components such as flavor amino acids, oligopeptides, nucleotides, organic bases, organic acids, and sugar alcohols, etc. Compared with marine animal products, seaweed has a lower lipid oxidation rate and a unique nutritional value. Gracilaria is one of the main red algae producing agar in China, commonly known as dragon beard vegetables, edible seaweed and line vegetables. It is a large economic seaweed widely distributed in coastal areas such as Guangdong and Hainan Provinces. It is rich in active polysaccharides, proteins, dietary fiber, minerals, and polyunsaturated fatty acids, etc. It has high nutritional value and unique flavor, and is known as the treasure of vegetarian vegetables in the sea. Gracilaria bailinae, with a less alginate and a crisp taste, is an edible high-quality seaweed.

Gracilaria resources are abundant, and dried Gracilaria has a protein content of more than 20%, and is rich in umami amino acids, of which flavor amino acids account for more than 48% of the total amino acids, which is a plant protein resource with development potential thereof. A development and utilization of Gracilaria is mainly reflected in the fields of medicines and foods. 1) As a medicinal raw material, active ingredients with anticoagulant, antioxidant, antiviral, antibacterial, and antihypertensive functions can be extracted, such as polysaccharides, sesquiterpenes, diterpenes, triterpenes, steroids, fatty acids, and phenols; 2) As a raw material for preparing gelatin, and it can prepare agar-agar; 3) As a food raw material, it can be eaten directly, or made into food raw materials or food additives by extracting algae components thereof. Chinese patent publication NO. CN101475651A discloses a method for preparing polysaccharides from Gracilaria, which can be extracted from Gracilaria algae and applied in the preparation of anti-tumor and anti-cancer drugs. Chinese patent publication NO. 105767624A discloses a Gracilaria heat-clearing black rice cake and a production method thereof, which combines Gracilaria with rice cake to obtain the Gracilaria heat-clearing black rice cake that can effectively improve people's physical condition.

### SUMMARY

In order to develop and utilize Gracilaria resources and improve bioavailability of Gracilaria nutrients, the present disclosure provides a seaweed starter material and a preparation method thereof. In a conventional reparation process of a soy sauce starter material, a Gracilaria raw material is added to prepare a fermented flavor base material with seaweed flavor. Compared with a conventional sauce starter, the seaweed starter that is prepared has a significantly increased number of spore counts, a good fermentation performance, stronger enzyme secretion ability of enzyme-producing strains, and unique flavor.

In order to solve the above objectives, a preparation method of a seaweed starter according to an embodiment of the present disclosure includes: wetting cooked soybean meal with water, adding wheat meal and stirring same, adding seaweed meal to obtain a fermentation raw material and sterilizing same; adding a starter-making strain spore suspension into the sterilized fermentation raw material, performing constant-temperature culture, and performing ventilation and starter making for 48-96 hours to obtain a seaweed starter.

The starter-making strains are aspergillus oryzae and aspergillus niger, and wherein in terms of a mass ratio, a strain ratio of aspergillus oryzae to aspergillus niger is 1:1-1:5.

In terms of a mass ratio, an inoculum amount of the starter-making strain spore suspension is 3-5% of the fermentation raw material.

The seaweed meal is Gracilaria meal, and in terms of a mass ratio, an addition ratio of the cooked soybean meal to the wheat meal to the Gracilaria meal is 5:2:1-3.

Wherein the strain ratio of aspergillus oryzae to aspergillus niger is 1:2-1:4.

Wherein a preparation method for the Gracilaria meal is that washing fresh Gracilaria leaves with salt, cleaning thoroughly, performing air dry at a temperature of 55-65° C. until a moisture content is 5-9%, and then grinding to obtain the Gracilaria meal; and wherein a protein content of the Gracilaria meal is 24-30%, a total sugar content is 57-65%, and a fat content is 0.24-0.5%.

Wherein high-quality soybeans are selected and soaked to swell, then stir-fried at high temperature and high heat to be matured quickly, and then grinded into the cooked soybean meal with a mellow aroma, wherein a protein content of the cooked soybean meal is 32.7-40%, and a fat content is 18-20%.

Wherein the wheat meal with strong wheat aroma is selected, a protein content of the wheat meal is 12-15%, and a fat content is 1.3-2%.

Wherein sterilization conditions for the fermentation raw material are: performing sterilization for 15-20 minutes at a temperature of 121° C. and a pressure of 0.1 MPA, wherein a constant-temperature culture temperature is 28 ° C.; during the ventilation and starter-making process, a starter material needs to be shaken and dispersed every 24 hours until the starter-making process is completed. After the starter-making is completed, the starter material is fluffy, densely covered with mycelium and covered with black spores, wherein the starter material is black with a slight yellow-green color, and has a strong starter aroma and a slight algae smell.

On the other hand, the present disclosure provides a seaweed starter, which is prepared by the above-mentioned method, using the cooked soybean meal, the wheat meal, and the Gracilaria as raw materials, selecting aspergillus oryzae and aspergillus niger with high enzyme activity as the starter-making strains, and the starter-making process includes performing pretreatment on the starter-making raw materials, screening of enzyme-producing strains, performing solid-state high-pressure steaming and preparing the seaweed starter. Specifically, the following steps are included:

1) selecting high-quality soybeans and soaking and swelling the high-quality soybeans, then performing stir-fried at high temperature and high heat to be matured quickly, and then grinding into the cooked soybean meal with a mellow aroma, wherein a protein content of the cooked soybean meal is 32.7-40%, and a fat content is 18-20%; and selecting the wheat meal with strong wheat aroma, wherein a protein content of the wheat meal is 12-15%, and a fat content is 1.3-2%.

2) Selecting red algae Gracilaria, which is rich in active polysaccharides, proteins, dietary fiber, minerals, polyunsaturated fatty acids, etc., and has high nutritional value and unique flavor. Washing fresh Gracilaria leaves with salt, cleaning thoroughly, performing air dry in an oven at a temperature of 55-65° C. until a moisture content is 5-9%, wherein a protein content of dried Gracilaria is 24-30%, a total sugar content is 57-65%, and a fat content is 0.24-0.5%.

3) Selecting aspergillus oryzae and aspergillus niger with high enzyme activity as the starter-making strains. Aspergillus oryzae is provided by Guangdong Institute of Microbiology and is numbered 3.042. Black aspergillus niger is purchased from China Industrial Microbiological Culture Collection and Management Center and is numbered CICC2475. Adjusting the strain ratio of aspergillus oryzae and aspergillus niger to enable coordinated symbiosis between the two strains and maximize an enzyme production capacity thereof.

4) Wetting the cooked soybean meal with 0.9 to 1.6 times (by a mass) of water for 20 to 30 minutes, adding the wheat meal and stirring evenly, and then adding the Gracilaria meal to obtain the fermentation raw material.

5) The fermentation raw material obtained in the step 4) is sterilized at a temperature of 121° C. and a pressure of 0.1 MPa for 15 to 20 minutes. After being cooled, inoculating with a spore suspension of aspergillus oryzae and aspergillus niger at an inoculation amount of 3-5% of the mass of the fermentation raw material (about 1×10⁷ spores/mL). The fermentation raw material is cultured in a constant-temperature incubator at a temperature of 28° C. for 48 hours to 96 hours, and then performing ventilation and starter making, wherein the starter material is shaken and dispersed every 24 hours until the starter-making process is completed. After the starter-making is completed, the starter material is fluffy, densely covered with mycelium and covered with black spores, wherein the starter material is black with a slight yellow-green color, and has a strong starter aroma and a slight algae smell.

Furthermore, the present disclosure provides an application of seaweed meal in improving quality of a sauce starter that includes: adding seaweed meal to a sauce starter fermented raw material, wherein the seaweed meal is Gracilaria meal. It is known through experiments that the Gracilaria meal increases the spore count of the starter-making strains in the sauce starter, reduces a solid content in the sauce starter, and increases the enzyme activity of the starter-making strains in the sauce starter.

Compared with the related art, the technical solution provided by the present disclosure has at least the following beneficial effects or advantages:

On the basis of the conventional starter-making process, the present disclosure provides the Gracilaria meal as the starter making raw material and adopts a plurality of strains to perform collaborative starter-making, thereby improving the comprehensive enzyme activity of the seaweed starter and increasing the number of starter spores, providing high-quality seed starter for seafood flavor fermentation seasonings, and promoting the high-value utilization of the seaweed resources. At the same time, the present disclosure effectively solves the technical problems that the conventional sauce starter has a single flavor and the enzyme activity of a single strain is insufficient.

The method of the present disclosure applies Gracilaria to the soy sauce starter, utilizes a rich enzyme system that is produced by the starter to degrade the nutrients and fishy substances in the red algae, enriches flavor substances of the red algae, and endows the seaweed starter system with new flavor substances, which is of great significance in brewing and developing seafood-flavor soy sauce by using fermented seaweed.

### BRIEF DESCRIPTION OF THE DRAWINGS

In order to more clearly understand the technical solution hereinafter in embodiments of the present disclosure or the related art, a brief description to the drawings used in detailed description of embodiments hereinafter is provided thereof. Obviously, the drawings described below are some embodiments of the present disclosure.

FIG. 1 is a schematic chart of a result of measuring enzyme activities of acidic protease and saccharifying enzyme that a Gracilaria starter is inoculated with a single strain and a combination strain of the present disclosure.

FIG. 2 is a comparison chart of the enzyme activities of acid protease and saccharifying enzyme under different strain ratios of the present disclosure.

FIG. 3 is a comparison chart of spore counts that are prepared by a conventional sauce starter and the Gracilaria starter of the present disclosure.

FIG. 4 is a comparison chart of solid contents that are prepared by the conventional sauce starter and the Gracilaria starter of the present disclosure.

FIG. 5 is a chart of enzyme activity measurement results of acidic protease, saccharifying enzyme, amylase, cellulase, pectinase and aminopeptidase that are prepared by the conventional sauce starter and the Gracilaria starter of the present disclosure.

### DETAILED DESCRIPTION

The technical solution of the present disclosure is now described in conjunction with embodiments, however, the present disclosure is not limited to the following embodiments. The experimental methods and detection methods described in the following embodiments, unless otherwise specified, are conventional methods; reagents and materials described below are all commercially available unless otherwise specified.

### A First Embodiment

A preparation method of a seaweed starter according to an embodiment of the present disclosure includes the following steps:
selecting high-quality soybeans and soaking and swelling the high-quality soybeans, then performing stir-fried at high temperature and high heat to be matured quickly, and then grinding to obtain cooked soybean meal (it is preferable that a mesh size of the soybean meal is 80 meshes). Preferably, a protein content of the cooked soybean meal is 32.7-40%, and a fat content is 18-20%, which can be taken as a raw material for preparing the seaweed starter of the embodiment.
selecting wheat meal with strong wheat aroma, wherein a protein content of the wheat meal is 12-15%, and a fat content is 1.3-2%, which can be taken as the raw materials for preparing the seaweed starter of the embodiment.

In an embodiment of the present disclosure, Gracilaria bailinae is selected to produce Gracilaria meal (it is preferable that a mesh size of the Gracilaria meal is 60-80 meshes), which is rich in active polysaccharides, proteins, dietary fiber, minerals, and polyunsaturated fatty acids, etc. It has high nutritional value and unique flavor. Washing fresh Gracilaria bailinae with salt, cleaning thoroughly, performing air dry in an oven at a temperature of 55-65° C. until a moisture content is 5-9%, wherein a protein content of dried Gracilaria bailinae is 24-30%, a total sugar content is 57-65%, and a fat content is 0.24-0.5%, which can be taken as the raw materials for preparing the seaweed starter of the embodiment. Preferably, after being dried, performing air dry in an oven at a temperature of 60° C. until the moisture content reaches 7%.

Mixing 50 parts of cooked soybean meal, 20 parts of wheat mral, and 10-30 parts of Gracilaria bailinae meal with water. Preferably, taking 50 parts of cooked soybean meal first, adding water to wet the cooked soybean meal for 20-30 minutes, and an amount that water is added should be 0.9-1.6 times a mass of the cooked soybean meal. Adding 20 parts of wheat meal and 10-30 parts of Gracilaria bailinae meal to the wet cooked soybean meal, and stirring evenly to obtain the fermentation raw material. Performing sterilization treatment on the fermentation raw material at a temperature of 121° C. and a pressure of 0.1 MPa for 15-20 minutes, and cooling to a temperature of 30-40° C., and controlling the moisture content of the starter to 40-46%. Inoculating a combination strain spore suspension into the starter material, wherein an inoculation amount of the spore suspension is 3-5% of a mass of the starter material. In the embodiment of the present disclosure, the combination strain is aspergillus oryzae and aspergillus niger, with a mixed mass ratio of 1:1-1:5. Aspergillus oryzae is provided by Guangdong Institute of Microbiology and is numbered 3.042. Black aspergillus niger is purchased from China Industrial Microbiological Culture Collection and Management Center and is numbered CICC2475. Preferably, adding 20 parts of wheat meal to the wet cooked soybean meal, stirring evenly and then adding 10-30 parts of Gracilaria bailinae meal to obtain the fermentation raw material. Preferably, a mass ratio of the cooked soybean meal, the wheat meal, and the Gracilaria bailinae meal is 50:20:20, the inoculation amount of the spore suspension is 3% of the mass of the starter, and the mixed mass ratio of aspergillus oryzae to aspergillus niger is 1:2-1:4. Preferably, the mixed mass ratio of aspergillus oryzae to aspergillus niger is 1:3.

In a constant-temperature incubator at a temperature of 28° C., performing ventilation and starter making for 48˜96 hours. Shaking and dispersing the starter material every 24 hours until the starter making is completed. The starter material is densely covered with hyphae and spores, wherein the starter material is black with a slight yellow-green color, and has a strong starter aroma and a slight algae smell. Preferably, a time of the ventilation and starter making is 96 hours.

### A Second Embodiment

Based on the description of the first embodiment, in the second embodiment of the present disclosure, a seaweed starter and a preparation method thereof are provided to measure and compare the enzyme activities of the starter making with a single strain and a combination strain.

Taking 50 parts of cooked soybean meal, adding water to wet the cooked soybean meal for 30 minutes, and an amount that water is added is 1.2 times a mass of the cooked soybean meal. Adding 20 parts of wheat meal to the wet cooked soybean meal, and stirring evenly, and then adding 20 parts of Gracilaria bailinae meal to obtain the fermentation raw material. Performing sterilization treatment on the fermentation raw material at a temperature of 121° C. and a pressure of 0.1 MPa for 20 minutes, and cooling to a temperature of 30° C.

Setting up three comparative experiments, in a first comparative example, a single aspergillus oryzae is inoculated into the starter material, and an inoculation amount of aspergillus oryzae spore suspension is 3% of a mass of the starter material. In a second comparative example, a single aspergillus niger is inoculated into the starter material, and an inoculation amount of aspergillus niger spore suspension is 3% of the mass of the starter material. In a third comparative example, a spore suspension of a combination strain is inoculated into the starter material, and an inoculation amount of the combination strain spore suspension is 3% of the mass of the starter material, and a mixed mass ratio of aspergillus oryzae to aspergillus niger is 1:3.

The three comparative examples are all performed ventilation and starter-making in a constant temperature incubator at a temperature of 28° C. for 96 hours, and the starter is shaken and dispersed every 24 hours until the starter making is completed.

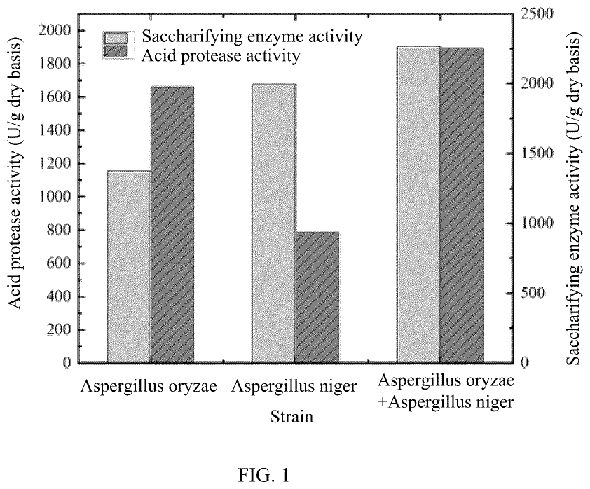

Accurately weighing 5.0 g of finished starter into a mortar, taking 100 mL of distilled water, adding a small amount of distilled water for grinding the finished starter, pouring into a conical flask with a volume of 250 mL after being sufficiently grinded, using the remaining distilled water to rinse the remaining starter sample into the conical flask, shaking evenly and placing in a water bath with a temperature of 40° C. and stirring for 60 minutes, then performing centrifuge at a speed of 8000 r/min and a temperature of 4° C. for 20 minutes to collect a supernatant, wherein the supernatant is a crude enzyme solution. The enzyme activities of acid protease and saccharifying enzyme of the crude enzyme solution are measured, wherein results are shown in FIG. 1.

As shown in FIG. 1, it can be seen that under the same starter making conditions, the enzyme activities of acid protease and saccharifying enzyme of the combination of aspergillus oryzae and aspergillus niger are significantly higher than those of a single strain. The mixed mass ratio of aspergillus oryzae to aspergillus niger is 1:3, which also indicates that under the ratio, the two have a synergistic effect.

### A Third Embodiment

The third embodiment provides an analysis of effects that different strain ratios of aspergillus oryzae to aspergillus niger are applied on enzyme activities.

The fermentation raw materials, sterilization, ventilation for starter-making, preparation and determination methods of the crude enzyme solution are the same as those of the second embodiment, with the exception of the mixed mass ratio of aspergillus oryzae to aspergillus niger. The spore suspension of the combination strain (aspergillus oryzae and aspergillus niger) is inoculated into the starter material, the inoculation amount of the combination strain spore suspension is 3% of a mass of the starter material, and the mixed mass ratio of aspergillus oryzae to aspergillus niger are set to 1:1, 1:2, 1:3, 1:4, 1:5, respectively.

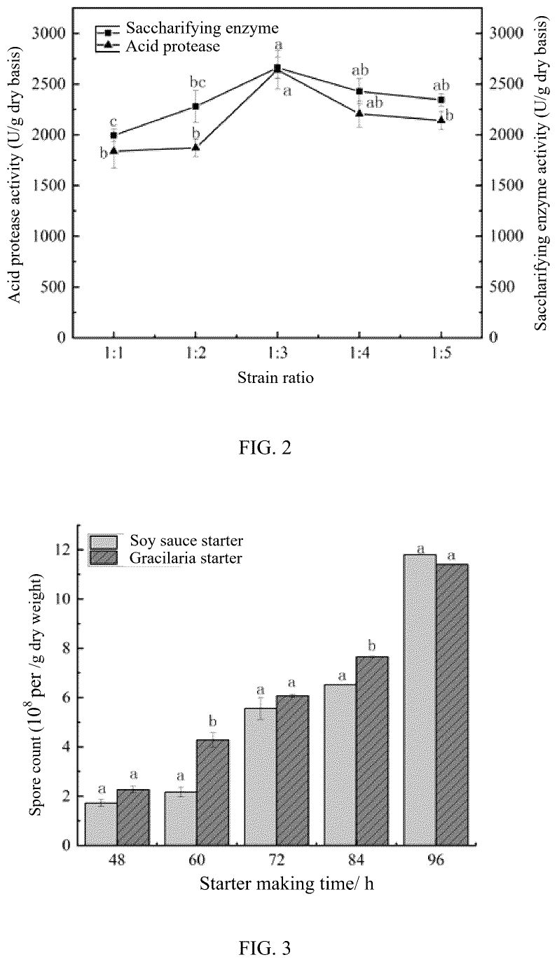

A measurement result of the enzyme activities of acid protease and saccharifying enzyme in the crude enzyme solution is shown in FIG. 2. As a compound ratio of aspergillus oryzae to aspergillus niger increases, the activities of both acid protease and saccharifying enzyme are shown a trend of increasing first and then decreasing. When the ratio of aspergillus oryzae to aspergillus niger is 1:2-1:4, it is beneficial for synergistic symbiosis of aspergillus oryzae and aspergillus niger in the finished starter, for promoting their metabolism and enzyme production. When the ratio of aspergillus oryzae to aspergillus niger is 1:3, the best effect on promoting metabolism and enzyme production is occurred.

### A Fourth Embodiment

Preparation of Gracilaria starter: taking 50 kg of cooked soybean meal, adding water to wet the cooked soybean meal for 25 minutes, and an amount that water is added is 1.5 times a mass of the cooked soybean meal. Adding 20 kg of wheat meal to the wet cooked soybean meal, and stirring evenly, and then adding 10 kg of Gracilaria bailinae meal to obtain the fermentation raw material. Performing sterilization treatment on the fermentation raw material at a temperature of 121° C. and a pressure of 0.1 MPa for 30 minutes, and cooling to a temperature of 35° C. Inoculating a combination strain spore suspension (aspergillus oryzae and aspergillus niger) into the starter material, wherein an inoculation amount of the combination strain spore suspension is 5% of a mass of the starter material. A mixed mass ratio of aspergillus oryzae to aspergillus niger is 1:3. In a constant-temperature incubator at a temperature of 28° C., performing ventilation and starter making, and shaking and dispersing the starter material every 24 hours until the starter making is completed. The starter making time can be set to 48 hours, 60 hours, 72 hours, 84 hours and 96 hours, respectively. Samples are taken at different starter making times to detect the number of spores in the samples.

A preparation of a conventional sauce starter is different from the preparation of Gracilaria starter that no Gracilaria bailinae meal is added, and the rest of the starter making method are the same as that of the Gracilaria starter.

Accurately weighing 2.5 g of the finished starter sample (accurate to 0.002 g), pouring the finished starter sample into a conical flask with a volume of 100 mL, adding 50 mL of sterile water, shaking thoroughly to disperse the conidia, then filtering and rinsing with lens paper to make the filter residue free of spores, and then to being diluted. Using a hemocytometer to count, observing and counting each sample three times, and taking an average value thereof, which is the number of spores of the sample.

The number of spores can directly reflect a growth status of the strain during the starter-making process, which is an important indicator for measuring the quality of the finished starter. An increase in the number of spores can improve the enzyme production capacity of the finished starter. An experimental result is shown in FIG. 3. The number of spores of both the conventional sauce starter and the Gracilaria starter increase with the extension of the starter making time. When the starter making time is 48-84 hours, the number of spores of the Gracilariastarter is greater than that of the conventional sauce starter, and when the starter making time is 60 hours and 84 hours, there is a significant difference in the number of spores between the Gracilaria starter and the conventional sauce starter. When the starter making time is 96 hours, the number of spores of the conventional sauce starter is greater than that of the Gracilaria starter, but there is no significant difference therebetween.

### A Fifth Embodiment

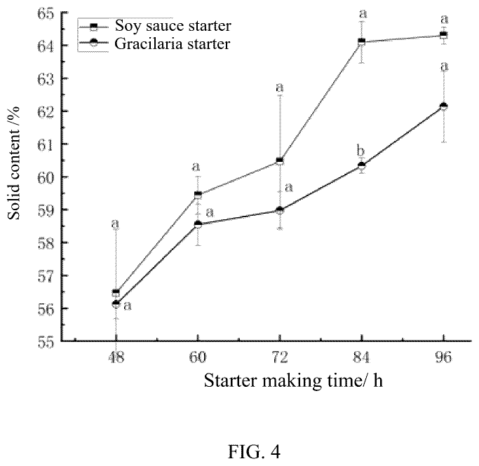

In the fifth embodiment, it is measured changes in solid content of the conventional sauce starter and the Gracilaria starter during the starter-making process. The preparation of the conventional sauce starter and the Gracilaria starter is the same as that of the fourth embodiment. The solid content is determined by a rapid moisture determination method, and each sample is measured for three times to take an average value thereof. A measurement result is shown in FIG. 4.

During the starter-making process, aspergillus oryzae and aspergillus niger grow and metabolize to produce enzymes, which is accompanied by consumption of nutrients in the starter material, a decrease in water content and an increase in the solid content. The solid content can indirectly reflect growth of microorganisms during the starter-making process to a certain extent.

As shown in FIG. 4, the solid content of both the conventional sauce starter and the Gracilaria starter are increased with the extension of the starter making time, while the solid content of the Gracilaria starter is lower than that of the conventional sauce starter during the starter-making process, which indicates that adding the Gracilaria meal can enhance the potential for growth and metabolism of aspergillus oryzae and aspergillus niger during the starter-making process, and have a higher ability to consume nutrients than the conventional sauce starter.

### A Sixth Embodiment

Preparation of Gracilaria starter: taking 50 kg of cooked soybean meal, adding water to wet the cooked soybean meal for 20 minutes, and an amount that water is added is 1.2 times a mass of the cooked soybean meal. Adding 20 kg of wheat meal to the wet cooked soybean meal, and stirring evenly, and then adding 20 kg of Gracilaria bailinae meal to obtain the fermentation raw material. Performing sterilization treatment on the fermentation raw material at a temperature of 121° C. and a pressure of 0.1MPa for 20 minutes, and cooling to a temperature of 30° C. Inoculating a combination strain spore suspension (aspergillus oryzae and aspergillus niger) into the starter material, wherein an inoculation amount of the combination strain spore suspension is 4% of a mass of the starter material. A mixed mass ratio of aspergillus oryzae to aspergillus niger is 1:3. In a constant-temperature incubator at a temperature of 28° C., performing ventilation and starter making for 72 hours, and shaking and dispersing the starter material every 24 hours until the starter making is completed.

A preparation of a conventional sauce starter is different from the preparation of Gracilaria starter that no Gracilaria bailinae meal is added, and the rest of the starter making method are the same as that of the Gracilaria starter.

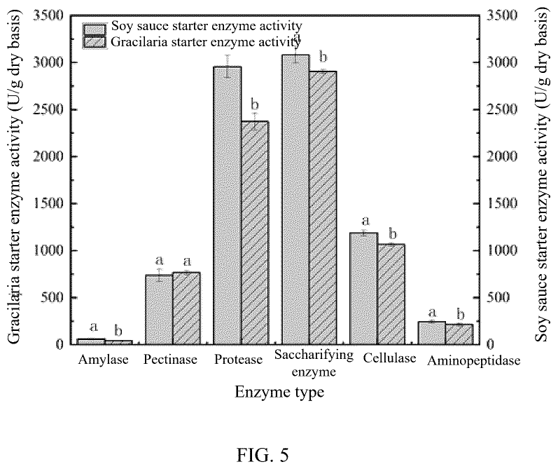

The preparation of the crude enzyme solution is the same as that of the second embodiment. The enzyme activities of acid protease, saccharifying enzyme, amylase, cellulase, pectinase and aminopeptidase in the crude enzyme solution are measured, and results are shown in FIG. 5.

As shown in FIG. 5, there is a difference in the enzyme activity of the same enzyme between the Gracilaria starter and the conventional sauce starter. Proteases and saccharifying enzymes are key enzymes that affect the presentation of flavor substances such as alcohols, acids, esters, aldehydes, furans and pyrazines in the later stage of soy sauce fermentation. The activities of acid protease and saccharifying enzyme of the Gracilaria starter are higher than that of the conventional sauce starter, which indicates that the Gracilaria starter can improve a utilization rate of protein and carbohydrate substances in the raw materials, which is beneficial to increase a dissolution of soluble nitrogen and monosaccharides during the fermentation process, and improve the flavor of the Gracilaria starter in the late fermentation. Aminopeptidase can indirectly affect a umami taste of the fermentation product by hydrolyzing polypeptides to release free amino acids (such as aspartic acid and glutamic acid). The activities of amylase and aminopeptidase in the Gracilaria starter are higher than that of the soy sauce starter, which indicates that adding Gracilaria has a certain promoting effect on the activity of amylase and aminopeptidase produced by mixed starter making of aspergillus oryzae and aspergillus niger. An activity of pectinase in the Gracilaria starter is lower than that of the soy sauce starter, but there is no significant difference therebetween. Compared with an activity of cellulase in the soy sauce starter, the activity of cellulase in the soy sauce starter with added Gracilaria is higher.

Although the features and elements of the present disclosure are described as embodiments in particular combinations, each feature or element can be used alone or in other various combinations within the principles of the present disclosure to the full extent indicated by the broad general meaning of the terms in which the appended claims are expressed. Any variation or replacement made by one of ordinary skill in the related art without departing from the spirit of the present disclosure shall fall within the protection scope of the present disclosure.

What is claimed is:

1. A preparation method of a seaweed starter comprising:
wetting cooked soybean meal with water, adding wheat meal and seaweed meal to obtain a fermentation raw material;
adding a starter-making strain spore suspension into the fermentation raw material, performing ventilation and starter making in a condition of constant-temperature, to obtain a seaweed starter; and wherein
starter-making strains are aspergillus oryzae and aspergillus niger, in terms of a mass ratio, a strain ratio of aspergillus oryzae to aspergillus niger is 1:1-1:5, and the seaweed meal is Gracilaria meal.

2. The preparation method as claimed in claim 1, wherein the step of adding the wheat meal and the seaweed meal to obtain the fermentation raw material, comprises: adding the wheat meal and stirring same, and then adding the seaweed meal to obtain the fermentation raw material;
performing sterilization treatment on the fermentation raw material; and wherein
a time range of performing ventilation and starter making in a condition of constant-temperature is between 48 hours to 96 hours.

3. The preparation method as claimed in claim 1, wherein in terms of a mass ratio, an inoculum amount of the starter-making strain spore suspension is 3-5% of the fermentation raw material; and wherein
in terms of a mass ratio, an addition ratio of the cooked soybean meal to the wheat meal to the Gracilaria meal is 5:2:1-3; and wherein
a preparation method for the Gracilaria meal is that washing fresh Gracilaria leaves with salt, cleaning thoroughly, performing air dry at a temperature of 55-65° C. until a moisture content is 5-9%, and then grinding to obtain the Gracilaria meal.

4. The preparation method as claimed in claim 1, wherein the strain ratio of aspergillus oryzae to aspergillus niger is 1:2-1:4.

5. The preparation method as claimed in claim 1, wherein a protein content of the Gracilaria meal is 24-30%, a total sugar content is 57-65%, and a fat content is 0.24-0.5%.

6. The preparation method as claimed in claim 1, wherein a protein content of the cooked soybean meal is 32.7-40%, and a fat content is 18-20%; and wherein a protein content of the wheat meal is 12-15%, and a fat content is 1.3-2%.

7. The preparation method as claimed in claim 1, wherein sterilization conditions for the fermentation raw material are: performing sterilization for 15-20 minutes at a temperature of 121 ° C. and a pressure of 0.1 MPa, wherein a constant-temperature culture temperature is 28 ° C.; during the ventilation and starter-making process, a starter material needs to be shaken and dispersed every 24 hours until the starter-making process is completed.

8. A seaweed starter is prepared according to the preparation method as claimed in any one of claims 1 to 7.

9. An application of seaweed meal in improving quality of a sauce starter comprising: adding seaweed meal to a sauce starter fermented raw material, wherein the seaweed meal is Gracilaria meal.

10. An application of the seaweed starter in medicines, agar-agar or foodstuffs as claimed in claim 8.
